(19) United States
(12) Patent Application Publication
(10) Pub. No.: US 2020/0068988 A1
(43) Pub. Date: Mar. 5, 2020

(54) FOAM MOLDED BODY, SHOE COMPONENT AND MANUFACTURING METHOD THEREOF

(71) Applicant: Sheng Long Material Tech. Ltd. (WS), Apia (WS)

(72) Inventor: CHIN-HSUN HSIAO, Taipei (TW)

(21) Appl. No.: 16/553,774

(22) Filed: Aug. 28, 2019

(30) Foreign Application Priority Data
Aug. 31, 2018 (TW) 107130725

(51) Int. Cl. A43B 13/18; B29D 35/12

(52) U.S. Cl. CPC A43B 13/188; B29K 2075/00; B29D 35/122

(57) ABSTRACT

The present invention provides a method for manufacturing a foam molded body, including: inputting a foam matrix material including a plurality of half-foamed granules of thermoplastic polyurethanes (TPU) into a mold that is not affected by microwave; and heating the mold by microwave, wherein the half-foamed granules in the mold are affected by microwave such that the temperature thereof are raised to conduct foaming and are squeezed with each other, so as to form the foam molded body after cooling and demolding. The half-foamed granules include a plurality of first granules within a first grain size range, and a plurality of second granules within a second grain size range, and the median of the first grain size range is substantially larger than the median of the second grain size range. The first granules and the second granules are respectively disposed in different regions in the mold.

### BACKGROUND

### Technical Field

The present invention relates to a foam molded body, a shoe component, and the manufacturing method thereof. Specifically, the present invention relates to using a manner of microwave heating to conduct foaming formed a foam molded body, a shoe component, and manufacturing method thereof.

### Related Art

Plastic/rubber molded bodies have been widely used in various fields in the world to prepare manufacture various utensils or products such as toys, shoes, auto parts, electronic parts, etc. According to the above, it is common to use injection molding to heat and melt plastic at a high temperature and inject it into a mold to form various plastic rubber molded bodies. However, in such a process, it is necessary to use an injection molding machine and a relatively high-temperature resistant mold, hence the configurations required and costs of the overall procedure are relatively high. In addition, the high temperature of injection molding is also disadvantageous component for adding any object to be embedded in the plastic/rubber molded body in the preparation. Therefore, it is necessary to develop plastic/rubber molded bodies of various structures and the methods for a preparation method for preparing such plastic/rubber molded bodies, and the corresponding detailed processes for various designs or products.

As described above, in order to provide other plastic/rubber molded bodies of other structures, Taiwan Patent Publication No. TW 201736423 A proposes a foamable composition which can be used for foaming, a foamed thermoplastic polyurethane (TPU) granules which is formed by foaming and granulation, and the microwave molded bodies produced by the same and corresponding manufacturing methods thereof; Taiwan Patent Publication No. TW 201736450 A proposes a method of forming a microwave molded body on the surface portion of an object and a microwave molded body thereof; and Taiwan Patent Publication No. TW 201736093 A proposes a method corresponding to formation of a microwave molded shoe and a microwave molded shoe produced therefrom. The above-mentioned Taiwan Patent Publication discloses several foamed granular materials especially designed to adjust the granule color or the granule hardness during granulation, and discloses fittings or objects that can be bonded with the foamed granular material by an adhesive layer or fused with the foamed granular material by microwave heating. However, the present invention further proposes materials that can be applied depending on the nature of microwave heating and various configurations of foaming, in order to further provide a method and a finished product thereof for preparing various detailed structures and configurations of microwave molded bodies.

### SUMMARY

### Technical Means for Problem Solving.

In order to solve the above problems, an embodiment of the present invention provides a method of manufacturing a foam molded body, comprising: a setting step of inputting a foam matrix material including a plurality of half-foamed granules of thermoplastic polyurethanes (TPU) into a mold that is not affected by microwave; and a foaming step of heating the mold by microwave, wherein the half-foamed granules in the mold are affected by microwave such that the temperature thereof are raised to conduct foaming and are squeezed with each other, so as to form the foam molded body after cooling and demolding. The half-foamed granules include a plurality of first granules within a first grain size range, and a plurality of second granules within a second grain size range, and the median of the first grain size range is substantially larger than the median of the second grain size range. In the setting step, the first granules and the second granules are respectively disposed in different regions in the mold.

According to another embodiment of the present invention, there is provided a foam molded body produced by the above method. In the foam molded body, the hardness of the part formed by foaming the first granules is less than the hardness of the part formed by foaming the second granules, and the density of the granules junction of the part formed by foaming the first granules is lower than the density of the granules junction of the part formed by foaming the second granules.

According to still another embodiment of the present invention, a shoe component produced by the above method is provided, and the shoe component is the foam molded body with the shape of a shoe component. In the shoe component, the hardness of the part formed by foaming the first granules is less than the hardness of the part formed by foaming the second granules, and the density of the granules junction of the part formed by foaming the first granules is lower than the density of the granules junction of the part formed by foaming the second granules.

According to still another embodiment of the present invention, providing a foam molded body comprising a structure formed by foaming a plurality of half-foamed granules of thermoplastic polyurethane (TPU). The half-foamed granules include a plurality of first granules within a first grain size range. The hardness of the part formed by foaming the first granules is less than the hardness of the part formed by foaming the second granules, and the density of the granules junction of the part formed by foaming the first granules is lower than the density of the granules junction of the part formed by foaming the second granules.

### Control the Efficacy of Prior Art

The method for manufacturing a foam molded body, the foam molded body and the shoe component according to the embodiments of the present invention can be configured by a grain size according to requirements and designs without any other specific procedures or materials. Each part of final product has a different hardness or softness. Therefore, the refinement and applicability of the foam molded body of the microwave molded can be improved.

### BRIEF DESCRIPTION OF THE DRAWINGS

FIG. 1 shows a flow chart of the manner of producing the foam molded body according to an embodiment of the present invention.

FIG. 2A to FIG. 2C shows schematic diagrams of setting the foam matrix materials according to one embodiment of the present invention.

FIG. 2D shows a schematic diagram of foaming by microwave heating according to an embodiment of the present invention.

FIG. 3 shows a schematic diagram of the foam molded body produced by the method shown in FIG. 2A to FIG. 2D.

FIG. 4 shows a schematic diagram of the foam molded body produced with a mold having a shape of a shoe component according to an embodiment of the present invention.

FIG. 5A to FIG. 5D shows schematic diagrams of setting foam matrix materials and partitions according to another embodiment of the present invention.

FIG. 5E shows a schematic diagram of the foaming by microwave heating according to another embodiment of the present invention.

FIG. 6A shows a schematic diagram of setting the foam matrix materials and the partitions according to still another embodiment of the present invention.

FIG. 6B shows a schematic diagram of the foaming by microwave heating according to still another embodiment of the present invention.

FIG. 7A shows a schematic diagram of setting foam matrix materials and embedded component in accordance with yet another embodiment of the present invention.

FIG. 7B shows a schematic diagram of the foaming by microwave heating in accordance with yet another embodiment of the present invention.

FIG. 8 shows a schematic diagram of the foam molded body produced by the method shown in FIG. 7A and FIG. 7B.

FIG. 9 shows a schematic diagram of setting foam matrix materials and film-like components in accordance with one embodiment of the present invention.

FIG. 10 shows a schematic diagram of the foam molded body produced by foaming by the microwave heating in the arrangement of FIG. 9.

FIG. 11A to FIG. 11E shows schematic diagrams of setting foam matrix materials and film-like component according to still another embodiment of the present invention.

FIG. 11F shows a schematic diagram of the foaming by microwave heating according to still another embodiment of the present invention.

FIG. 12 shows a schematic diagram of the foam molded body produced by the method shown in FIG. 11A to FIG. 11F.

FIG. 13A and FIG. 13B shows schematic diagrams of setting foam matrix materials, shoe last and upper according to another embodiment of the present invention.

FIG. 14 shows a schematic diagram of the shoe component produced by foaming in the manner of microwave heating and the shoe component bonded to the upper in the arrangement of FIG. 13A and FIG. 13B.

FIG. 15 shows a schematic diagram of setting foam matrix material and a shoe last and an upper according to a first variant embodiment of the present invention.

FIG. 16 shows a schematic diagram of the shoe component produced by foaming in the manner of microwave heating and insole and the shoe component bonded to the upper in the arrangement of FIG. 15.

FIG. 17 shows a schematic diagram of the setting foam matrix materials and a shoe last and an upper according to a second variant embodiment of the present invention.

FIG. 18 shows a schematic diagram of shoe component produced by foaming by microwave heating and the insole and shoe component bonded to the upper in the arrangement of FIG. 17.

### DETAILED DESCRIPTION

Various embodiments will be described hereinafter, and for one skilled in the art having ordinary knowledge in the description with reference to the drawings, the spirit and principle of the present invention should be readily understood. However, although some specific embodiments will be specified in this article, these embodiments are to be considered as illustrative and not restrictive or limiting. Therefore, for those who have general knowledge in the technical field of their own, without departing from the spirit and principles of the present invention, the various changes and modifications to the present invention should be obvious and easily achievable.

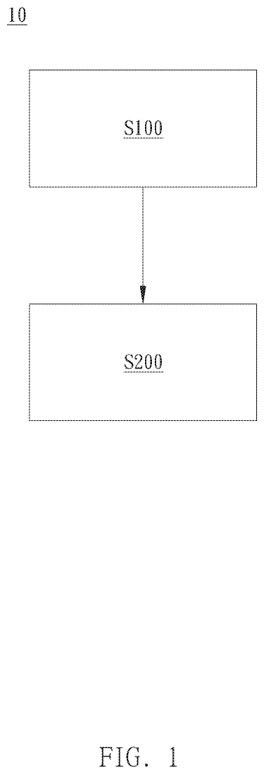

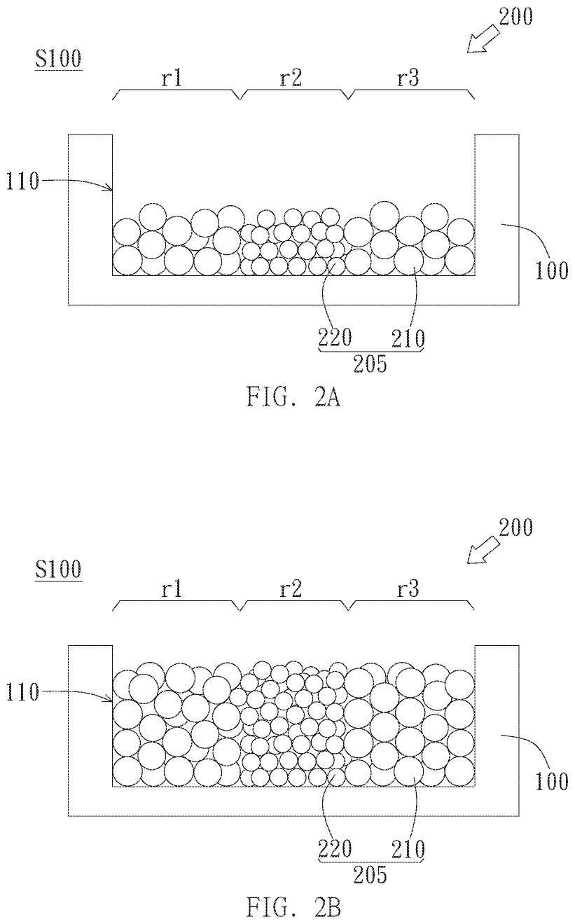

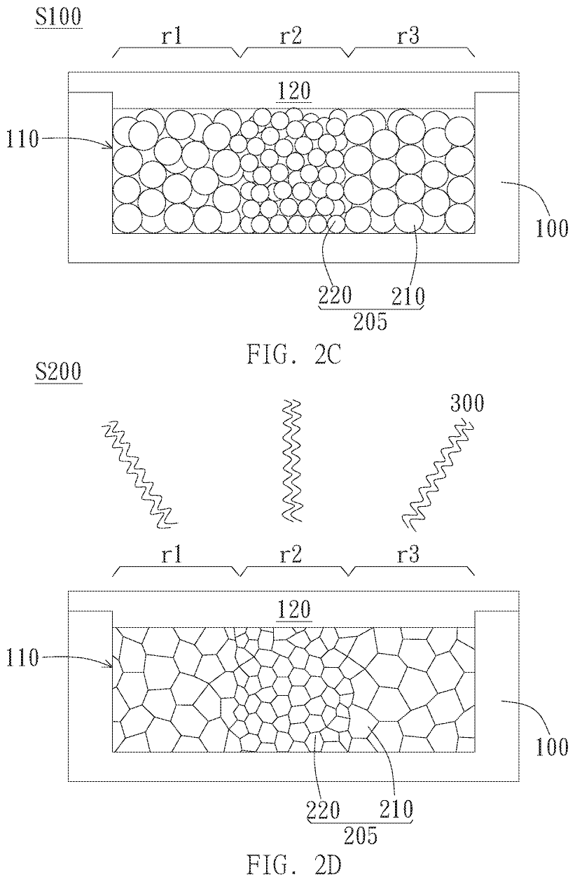

As shown in FIG. 1, a method 10 of fabricating a foam molded body according to an embodiment of the present invention includes a setting step S100 of setting foam matrix materials, and a foaming step S200 of foaming the foam matrix materials. for example, referring to FIG. 2A to FIG. 2C with FIG. 1, the method 10 according to the present embodiment, at first, the setting step S100 involves placing the foam matrix material 200 into the mold 100 i.e. into a cavity 110 of the mold 100) that is not affected by microwaves. In particular, “not affected by microwaves” means, for example, it cannot be heated in the manner of microwaves and can withstand the temperature rise of surrounding caused by microwave heating. Specifically, an ultra-transparent low-loss material allows microwaves to easily pass through and not be absorbed, or a completely opaque materials such as a metal conductor reflects all incoming microwaves and does not allow microwaves to penetrate, such materials that cannot be heated by microwaves if not raising the temperature by other surrounding materials to denature or variable (e.g., foaming), the materials all are not affected by microwave. Relatively speaking, the high-loss material sensitive to microwaves can absorb the microwaves just after a certain distance, so it can be heated by absorbing microwaves, which is a material that will be affected by microwaves. In addition, even if a material is not capable of directly absorbing microwaves and becoming heated, but under other materials in the periphery absorb microwaves to cause the temperature increased so as to denature or change (such as foaming), which is a material that is affected by microwaves.

As mentioned above, in accordance with one embodiment of the present invention, the foam matrix materials 200 comprises a plurality of half-foamed granules 205 which can foam by microwave heating directly or by the temperature rising in the result of heating the other adjacent material. For example, the half-foamed granules 205 in the foam matrix material 200 can be high loss materials that can be heated by microwave heating. Alternatively, in the case where the half-foamed granules 205 are materials which are difficult to be heated by microwaves, an additive which easily absorbs microwaves (for example, Al2O3-SiC, etc.) may be further added to the foam matrix materials 200 to make the half-foamed granules 205 can be foamed by the temperature increase caused by the absorption of microwaves by the surrounding additives.

Here, the mold 100 which is not affected by microwaves, for example, the mold 100 can be made of a material which is does not rise in temperature from being affected by microwave, and/or a material which can withstand high temperature without deformation. Furthermore, the mold 100 (the cavity 110 of the mold 100) can have various desired shapes to thereby produce a foam molded body with a desired shape, and may be an integrally formed component or assembled from a plurality of components.

According to some embodiments of the present invention, the half-foamed granules 205 can be made of polyurethane (PU), thermoplastic polyurethane (TPU) or thermoplastic elastomer (TPE), and may have foaming ability and formed a certain size of granules after foam to some extent. Specifically, the half-foamed granules 205 can be made from the materials of polyurethane (PU), thermoplastic polyurethane (TPU) or thermoplastic elastomer (TPE), which added a foaming agent and mixed after molded and through the incomplete foaming, and still retain foaming ability. For example, the half-foamed granules 205 can be formed by foaming thermoplastic polyurethane (TPU) by half-foamed. However, the present invention is not limited thereto, and the half-molded granules 205 can prepare by any means to have a certain degree of foaming and having a particle form while still retaining the foaming ability.

In detail, according to the present embodiment, the half-foamed granules 205 disposed in the mold 100 may include: a plurality of first granules 210 sized within a first grain size range, and a plurality of second granules within a second grain size range 220. Since the shape of the granules used with various embodiments of the present invention may not be a true sphere but a near sphere, the grain size is defined as the length of the largest axis of the granules. According to the present embodiment, the median of the first grain size range is substantially greater than the median of the second grain size range. That is, the first granules 210 are substantially larger than the second granule 220. For example, in a preferred embodiment, the median of the first grain size range is substantially equal to the average grain size of the first granule 210, and the median of the second grain size range is substantially equal to the average grain size of the second granule 220. However, due to factors such as process tolerances, there may be a difference in grain size between the plurality of first granule 210 or between the plurality of second granules 220, and the average grain size thereof is not necessarily equal to the median.

As shown in FIG. 2A and FIG. 2B, the different sizes of the first granule 210 and the second granule 220 may be respectively disposed in different regions in the mold 100. For example, the first granule 210 can be disposed in the region r1 and the region r3, and the second granule 220 can be disposed in the region r2. However, the above are merely examples, and the mold 100 can be divided into a plurality of different regions in other forms, and the first granule 210 and the second granule 220 can be respectively disposed in different regions. In addition, according to other embodiments of the present invention, it is also possible to further include other granules of different grain size ranges according to the above principles, and the granules are different from the first granule 210 and the second granule 220 and are additionally disposed in different regions. The present invention is not limited thereto.

According to a preferred embodiment, referring to FIG. 2C, the mold 100 may further include a top cover 120, and after the foam matrix material 200 is placed as shown in FIGS. 2A and 2B, by putting the top cover 120 on the mold 100, a space in which the foam matrix material 200 can be foam molded is defined.

Next, referring to FIG. 2D together with FIG. 1 and FIG. 2A to FIG. 2C, according to the method 10 of the present embodiment, the foaming step S200 includes heating the mold 100 in a microwave manner, so that the temperature of the half-foamed granules 205 in the mold 100 is raised by microwaves to conduct foaming and to squeezed with each other. That is, the mold 100 and the foam matrix material 200 including the above-described half-foamed granules 205 (i.e., the first granule 210 and the second granule 220) can be collectively heated by the microwaves 300. Thereby, the half-foamed granules 205 can be foamed (for example, foamed due to temperature rise itself caused by microwaves or temperature increase caused by surrounding materials such as additives). As a result, the surface of the half-foamed granules 205 can be squeezed and welded to each other due to foaming. Therefore, the integrally foamed molded body can be formed by cooling and demolding.

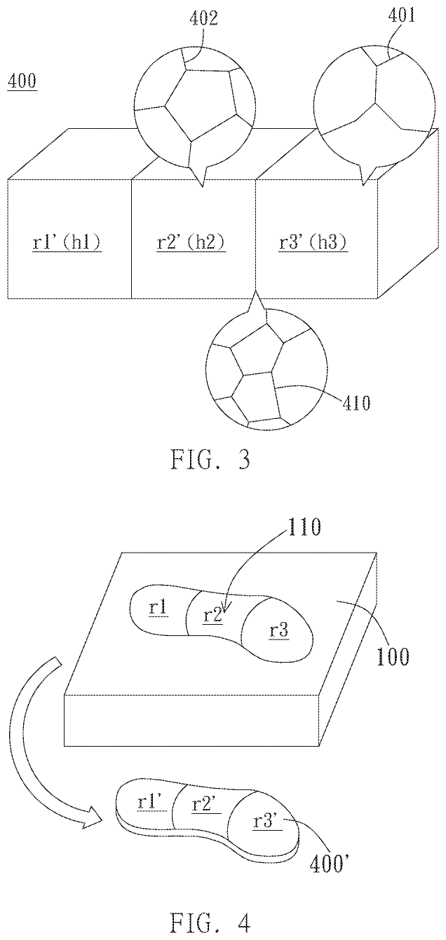

For example, referring to FIG. 3, according to an embodiment of the present invention, the foam molded body 400 produced by the method 10 for fabricating a foamed molded body described above with reference to FIG. 1 to FIG. 2D may be an integrally formed. That is, the foam molded body 400 is not scattered and is integrally viewed as an integrated article. Wherein, the half-foamed granules 205 corresponding to the region r1 in which the first granule 210 are originally disposed are formed as the first part r1′ of the foam molded body 400, corresponding to the half-foamed granules 205 of the region r2 in which the second granule 220 are originally disposed is formed as the second part r2′ of the foam molded body 400, and the half-foamed granules 205 corresponding to the region r3 where the first granules 210 are originally disposed are formed as the third part r3′ of the foam molded body 400. The second part r2′ formed by the smaller second granules 220 has a higher density relative to the first part r1′ and the third part r3′ formed by the larger first granule 210. Therefore, the second part r2′ may have a higher hardness with respect to the first part r1′ and the third part r3′. In detail, the hardness h2 of the second part r2′ may be higher than the hardness h1 of the first part r1′ and the hardness h3 of the third part r3′. That is, the hardness of the part formed by the first granule 210 may be less than the hardness of the part formed by the second granule 220. Further, as mentioned above, although only the first granule 210 and the second granule 220 are used in the present embodiment to form the foam molded body 400 having two different hardness or softness, according to other embodiments of the present invention, When it is expected that each part of the foam molded body 400 should have three or more hardness or softness, other granules having other grain size ranges may be added corresponding to the above principle, and the present invention is not limited thereto.

Continuing to refer to FIG. 3, in accordance with some embodiments of the present invention, the granules junction formed by the mutual fusion of the half-foamed granules 205 can be seen in the finished foam molded body 400. For example, the granules junction 401 in the first part r1′ and the third part r3′ formed by foaming the first granule 210 can be observed, and the granules junction 402 in the second part r2′ formed by foaming the second granule 220 can be observed. In addition, between the first part r1′ and the second part r2′, or between the third part r3′ and the second part r2′, the granules junction 410 formed by welded the first particles 210 to the second granules 220 can be observed. The density of the granules junction 401 of the part formed by foaming the first granules 210 may be lower than the density of the granules junction 402 of the part formed by the second granules 220. Further, according to some embodiments of the present invention, the granules junction of the foam molded body 400 may be difficult to distinguish by the naked eye, or even if the foaming is highly welded to each other to eliminate the granules junction. Therefore, the above description of the granules junction is merely an example, and the present invention is not limited thereto.

The above-mentioned foam molded body 400 can have various shapes depending on the shape of the mold 100 used in the setting step S100, and can be made into various products. For example, a foam molded body can be used as a shoe component. For example, referring to FIG. 4, in a method of fabricating a foam molded body according to another embodiment of the present invention, the cavity 110 of the mold 100 is in the shape of a shoe component. Therefore, after the setting step S100 and the foaming step S200 are performed similarly to the above, the foam molded body 400′ may have a shoe component shape (for example, a midsole, a shoe sole or an insole). That is, the shoe component is a foam molded body 400′ with a shoe component shape.

As described above, the shoe component of the foam molded body 400′ can control hardness or softness based on factors such as the comfort of the wearer's foot. For example, using the method 10 described above with reference to FIG. 1 to FIG. 3, disposed the first granule 210 with larger first grain size range to the regions r1 and r3 of the cavity 110, and disposed the second granule 220 with smaller second grain size range to the region r2 of the cavity 110, whereby each part of shoe component will have different hardness or softness after formed by foamed in the manner of microwave heating.

For example, similarly to the above description with reference to FIG. 3, in the foam molded body 400′, the hardness of the parts r1′ and r3′ formed by foaming the first granules 210 is less than the hardness of the part r2′ formed by foaming the second granules 220, and the density of the granules junction 401 of the parts r1′ and r3′ formed by foaming the first granules 210 is lower than the density of the granules junction 402 of the part r2′ formed by foaming the second granules 220. Wherein the softer parts r1′ and r2′ of the shoe component (e.g., midsole, outsole or insole) formed of the foam molded body 400′ may correspond to a part of the shoe component expected to contact foot palm of the wearer so as to increase wearing comfort, while the harder part r2′ of the shoe component correspond to the part which wearer's foot is not expected to contact to increase support. However, the above are merely examples, and the hardness or softness of each part of the foam molded body 400′ can be configured according to various designs and requirements to meet various needs. In addition, the shape of the cavity 110 of the mold 100 of FIG. 4 and the softness configuration and finished product of the foam molded body 400′ as the shoe component are merely examples, and the present invention is not limited thereto.

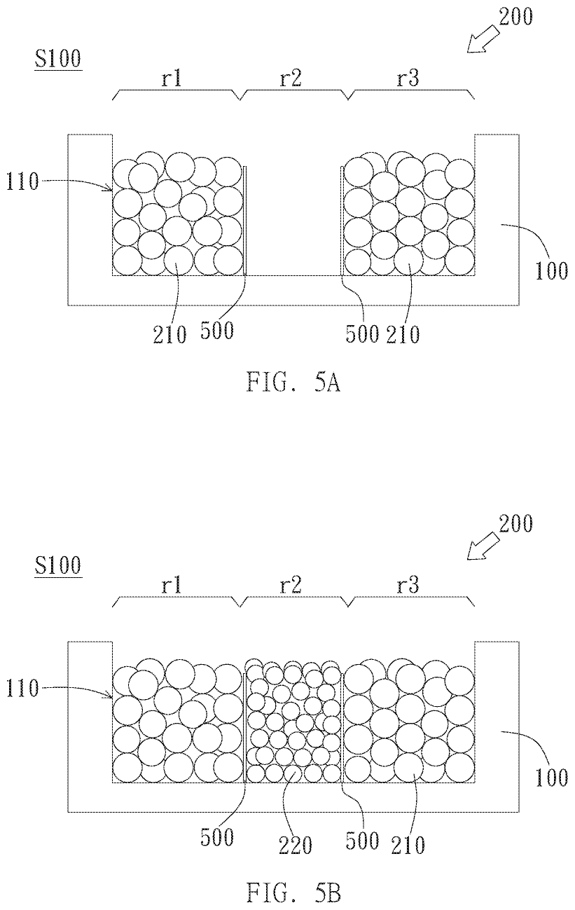

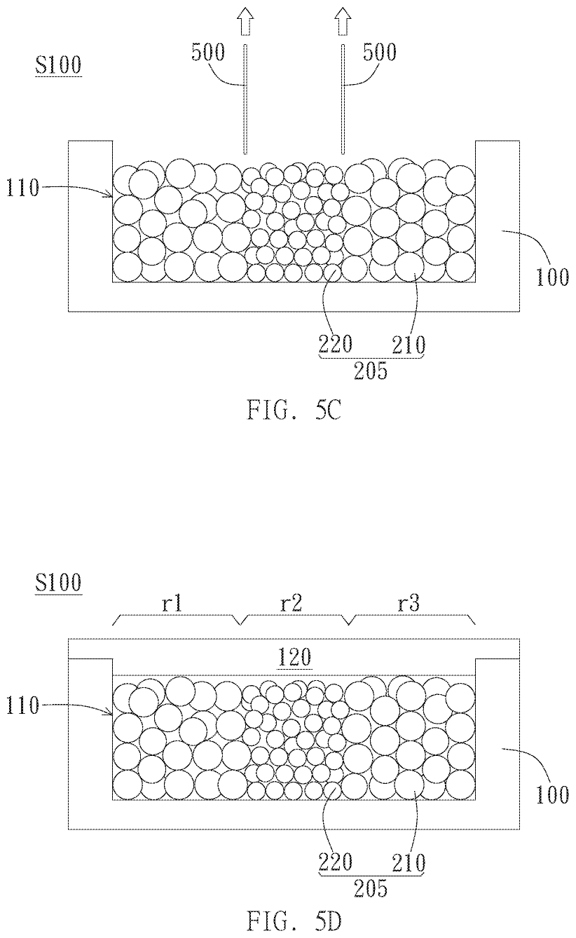

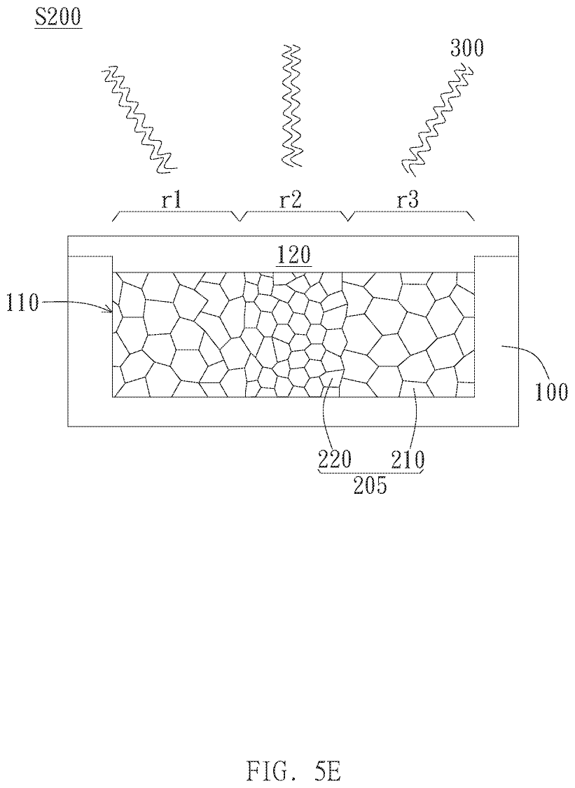

Further, referring to FIG. 5A and FIG. 5B, in accordance with still another embodiment of the present invention, in the setting step S100, in order to distribute the first granules 210 and the second granules 220 to different regions according to design or requirements, one or more partition 500 can be further placed into the mold 100 (i.e., into the cavity 100 of the mold 110) to divide the mold 100 into different regions r1, r2 and r3. Then, the first granules 210 and the second granules 220 are respectively placed in the different regions r1, r2 and r3 of the mold 100 which separated by the partitions 500. Specifically, the above-described embodiment as shown in FIG. 2A to FIG. 2B, placing different granules under no partition 500, preferably placed different granules at the same time to gradually increases its respective stack height, while the embodiment with the partition 500 as shown in FIG. 5A, the above-described process of placing different granules can be sequentially performed depending on the type of the granules. For example, as shown in FIG. 5A and FIG. 5B, the first granules 210 can be placed first to the intended regions r1 and r3, and then placing the second granules 220 to the intended region r2. However, this is merely an example, and the invention is not limited thereto.

According to one embodiment of the invention, after the first granules 210 and the second granules 220 have been set up, as shown in FIG. 5A and FIG. 5B; referring to FIG. SC, the partition 500 can be taken out before foaming step S200. And then, putting top cover 120 on it to conduct foaming (for example, foaming due to temperature rise itself cause by microwaves or temperature increase caused by surrounding materials such as additives) of foaming step S200 in the manner of microwave-heated, as shown in FIG. 5D and FIG. 5E. Thereby, the surfaces of the half-foamed granules 205 are welded to each other to form an integrally formed foam molded body similar to that shown in FIG. 3.

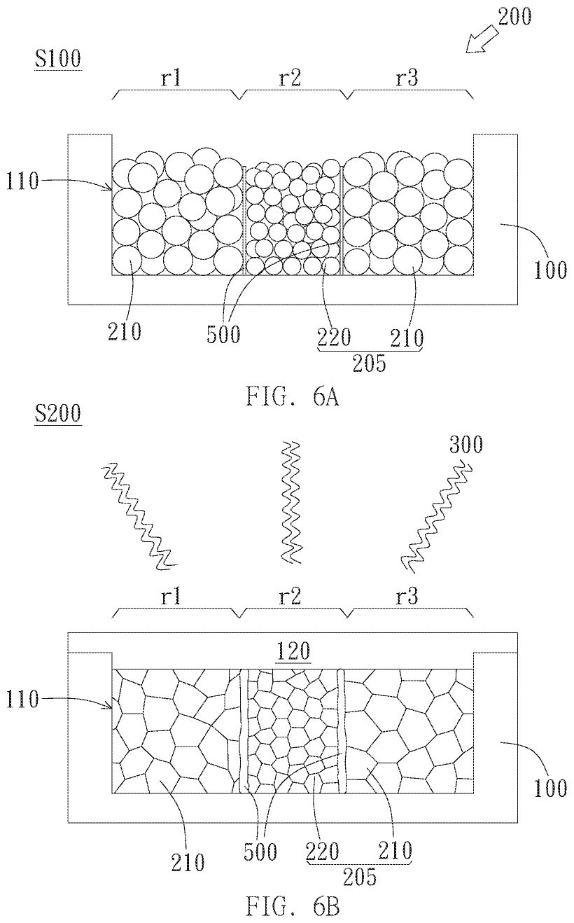

However, referring to another embodiment of the present invention shown in FIG. 6A and FIG. 6B, when the foam matrix material 200 and the partition 500 are disposed similarly to the above-described on the FIG. 5A and FIG. 5B, if the partition 500 is made of the half-foamed material that is similar to the half-foamed granules 205, and the partition 500 does not need to be taken out before the foaming step S200, and can be heated together with the half-foamed granules 205 by microwave to conduct foaming (for example, foaming due to temperature rise itself caused by microwaves or temperature increase caused by surrounding materials such as additives) in the foaming step S200. Thereby, the partition 500 can be squeezed and welded to the surfaces of the half-foamed granules 205 to form an integrally form foamed molded body.

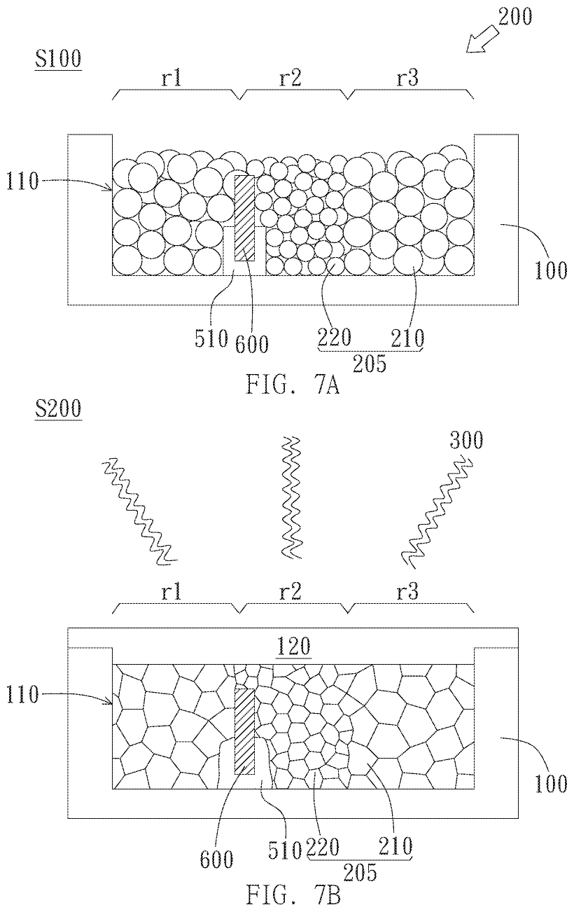

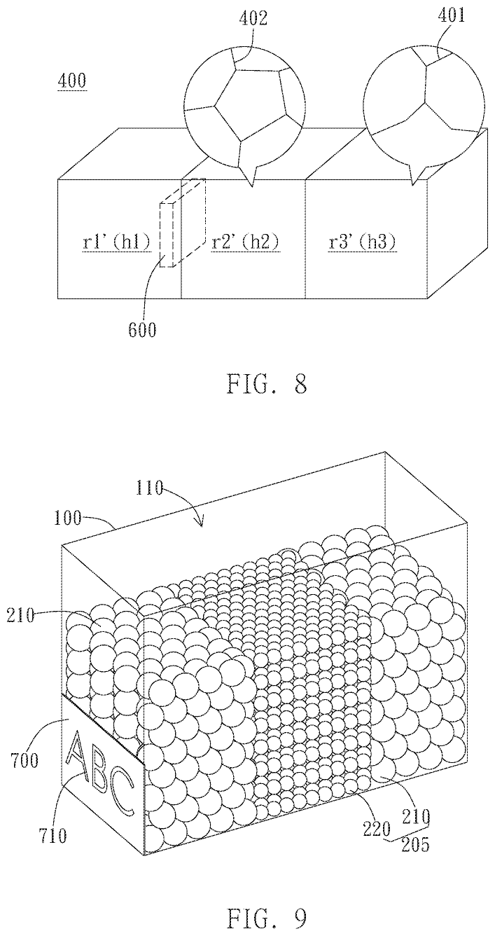

The method 10 for producing a foam molded body, the foam molded body 400, and the shoe component (i.e., the foam molded body 400′) described above with reference to FIG. 1 to FIG. 6B can further provided an embedded component as needed. For example, referring to FIG. 7A, before the foaming step S200, according to some embodiments of the present invention, an embedded component 600 can be further disposed in the mold 100 together with the half-foamed granules 205. Specifically, the embedded component 600 may be directly placed in the mold 100 to be arranged in common with the half-foamed granules 205, or using the positioning component of a base 510 with the same material as the partition 500 to place the embedded component 600, and the base 510 with the embedded component place in the mold 100 to be aligned with half-foamed granules 205. Wherein, the embedded component 600 is made of a material that is not affected by microwaves. For example, the embedded component 600 is made of a material that cannot be heated with the manner of microwaves, and thus the embedded component 600 retains its original properties and profile after microwaves. Therefore, referring to FIG. 7B, in the foaming step S200, the embedded component 600 is not subjected to microwave influence, for example, by microwave heating to foam. In contrast, selectively placing the base 510 for setting the embedded component 600 can be heated by microwave heating (for example, foaming due to temperature rise itself caused by microwaves or temperature increase caused by surrounding materials such as additives) to conduct foaming, and then squeezed and welded to the surfaces of the half-foamed granules 205 to form an integrally object. As mentioned above, the foamed half-foamed granules 205 can be welded to the selectively disposed base 510 due to foaming to cause the surface squeezed to each other, so that the embedded component 600 which is fixed also subject to extrusion. Thus, the integrally formed of the foam molded body 400 with the embedded component can be formed after cooling and demolding. Thereby, referring to FIG. 8 together with FIG. 7A and FIG. 7B, the embedded component 600 as a dissimilar material embedded in a foam molded body 400 integrally formed with different hardness in regions while retaining the original shape and functional properties. However, the method of embedding the embedded component 600 herein is by way of example only, and according to various embodiments, the embedded component 600 can be embedded with the way other than the above.

According to some embodiments of the present invention, for example, the embedded component 600 may include a wafer, a metal piece, or a material that is not polarized and cannot be heated by microwaves or any object that made from other materials that are not affected by microwaves, and can function as a decorative or functional component in the finished product of the foam molded body 400. For example, according to some embodiments of the present invention, the embedded component 600 can be a GPS tracking wafer, and the foam molded body 400 can be a shoe component made as similar to FIG. 4. Therefore, it is possible to track the real-time whereabouts of the sports event participants or the objects with self-care disability who are wearing the shoe body parts.

Further, according to other embodiments of the present invention, one or more film-like component 700 can be partially disposed in the mold 100 in the setting step S100 to contact with the half-foamed granules 205 (for example, the first granules 210 and/or the second granules 220). Wherein, the film-like component 700 can include, for example, a material that can be heated by microwaves. For example, the film-like component 700 can comprise a material similar to the half-foamed granules 205 or a material can be bonded to the half-foamed granules 205 after microwaves. For example, the film-like component 700 can comprise a material such as PU, TPU or TPE. Therefore, the film-like component 700 can be bonded to the foamed half-foamed granules 205 after microwave. As shown in FIG. 9, the second display panel 20 has a light emitting surface 21 and a light incident surface 22. The light incident surface 22 faces the light emitting surface 11 of the first display panel 10. The first lenses 30 are disposed between the first display panel 10 and the second display panel 20. As shown in FIG. 9, the first lenses 30 are disposed on the first surface 41 of the first lens diaphragm 40. One side of the first lens 30 opposite to the first surface 41 is attached to the light emitting surface 11 of the first display panel 10, and the second surface 42 of the first lens diaphragm 40 is attached to the light emitting surface 22 of the second display panel 20. In the embodiment of FIG. 9, no space is disposed between the first lens 30 and the first display panel 10 and between the first lens 30 and the second display panel 20.

For example, referring to FIG. 9, in addition to the semi-foamed granules 205 including the first granules 210 and the second granules 220, the film-like component 700 with the pattern 710 can be further disposed in the mold 100 in the setting step S100. In here, for convenience of display, the mold 100 of FIG. 8 is fluoroscopy, and the mold 100 defines the wall system of the cavity 110 is thin enough to be negligible.

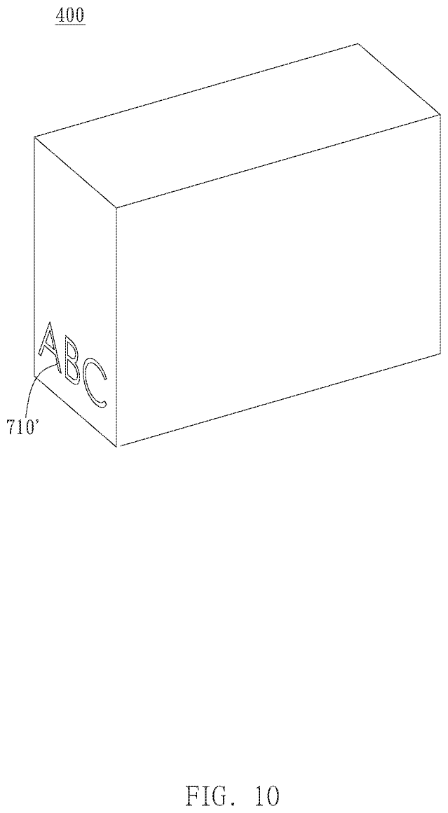

As described above, referring to FIG. 10, the configuration as shown in FIG. 9 after the foaming step S200, the film-like component 700 itself can be welded to the surface of the half-foamed granules 205 to form an integrally formed foamed molded body 400, and the pattern 710 original on the film-like component 700 are corresponding attached to the foam molded body 400 (the appearance of the foam molded body 400 as “printed” pattern 710).That is, the foam molded body 400 formed by the foaming has an indication pattern 710′ corresponding to the pattern 710. For example, this indication pattern 710′ can be described or designated of the foam molded body 400, or can be any decorative pattern. In detail, according to an embodiment, the film-like component 700 can be a non-foamed material, and can be a material having the same or similar properties as the thermoplastic polyurethane (TPU). Therefore, when the film-like component 700 is heated in a microwave manner, its surface is only slightly melted, and further formed an adhesion force with the half-foamed material (for example, the half-foamed granules 205) after foamed and squeezed by the microwave. In this case, since the film-like component 700 is not foamed, so that the film-like component 700 is not deformed and the original position of the pattern 710 is not changed or affected. Thereby, the indication pattern 710′ corresponding to the pattern 710 can be formed after the foaming step S200. Further, according to another embodiment, the film-like component 700 can be a non-foamed material and cannot be a material having the same or similar properties as the thermoplastic polyurethane (TPU). Therefore, the surface of the film-like component 700 will not melt as a dissimilar material when it is heated by the microwave method. In this case, the film-like component 700 and the half-foamed material (for example, the half-foamed granules 205) are not easily stabilized fixed but still can positioned and covered by half-foamed material after foamed to generate squeezed by microwave, and the original position of the pattern 710 will not change or be affected. Thereby, the indication pattern 710′ corresponding to the pattern 710 can be formed after the foaming step S200. However, the above are merely examples, and the present invention is not limited thereto.

In accordance with yet another embodiment of the present invention, at least one of the film-like component 700 can be a waterproof moisture permeable film (not shown in the drawings). Specifically, the waterproof moisture permeable film can assist in discharging the sweat of the human body in the form of water vapor, and can assist in isolating the infiltration of the external water liquid. For example, the waterproof moisture permeable film can have a waterproof capacity of 1000-2000 mm or more, and have more than 2000-3000 g/m²/24 hr moisture permeability. However, the above are merely examples, and the waterproof moisture permeable can be designed to have varying degrees of moisture permeable and waterproof capacity according to the requirements and expectations.

According to an embodiment of the present invention, the waterproof moisture permeable film may comprise or may be made of a material that can be heated by microwaves, and can comprises, for example, a material with similar properties to the half-foamed granules 205. For example, the waterproof moisture permeable film can comprise a material such as polyurethane (PU), thermoplastic polyurethane (TPU) or thermoplastic elastomeric (TPE) which does not foam or has a negligible foaming ability. As described above, at least a part of the half-foamed granules 205 can be further covered with a waterproof moisture permeable film before the foaming step S200. Therefore, since the material has commonality, after the foaming step S200, the waterproof moisture permeable film can be welded or covered fixed with at least a part of the formed foamed molded body 400.That is, at least a part of the foamed molded body 400 can be isolated or coated by a waterproof moisture permeable film that is substantially welded to the original or original structure, thereby improving the waterproof moisture permeable ability of at least a part of the formed foamed molded body 400.

Further, according to a further embodiment of the present invention, at least one of the film-like components 700 can comprise, for example, the foamable material that can be heated in a microwave manner to conduct foaming. Thereby, it can be used to form various detailed structures or shapes of the foam molded body 400 in accordance with the intended design.

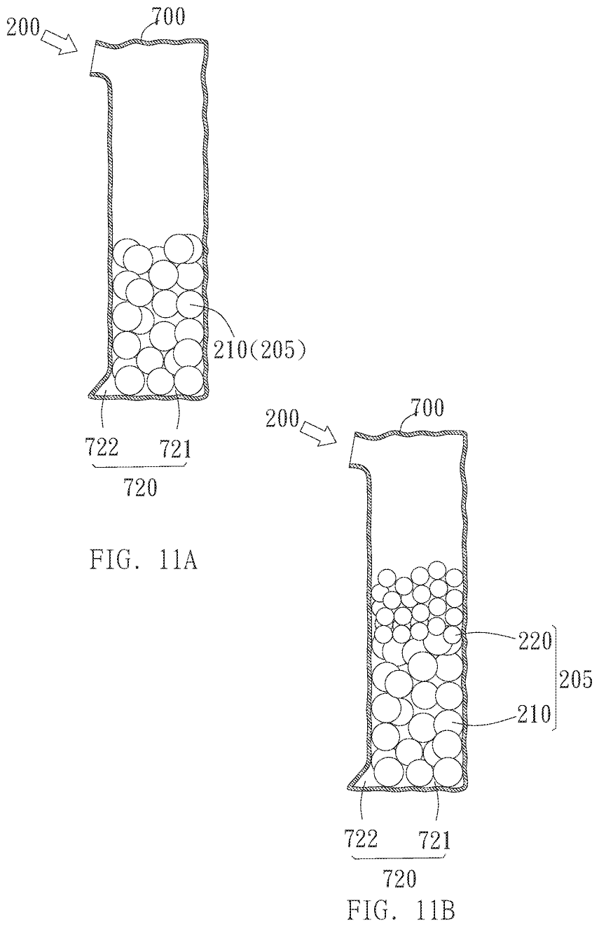

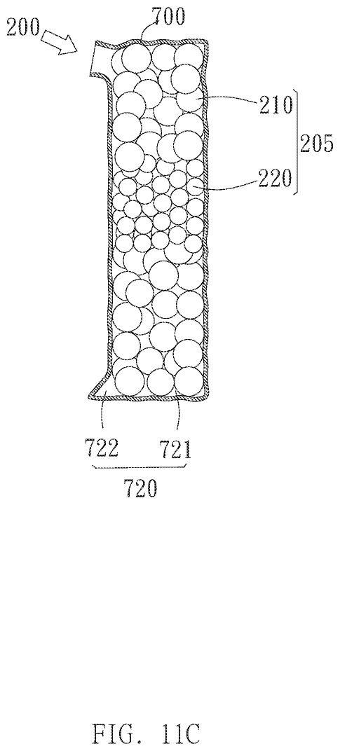

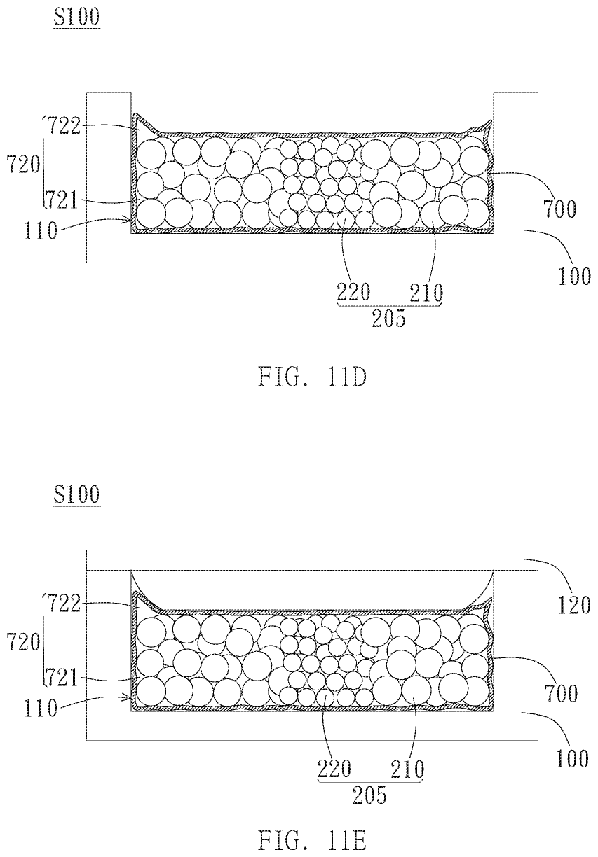

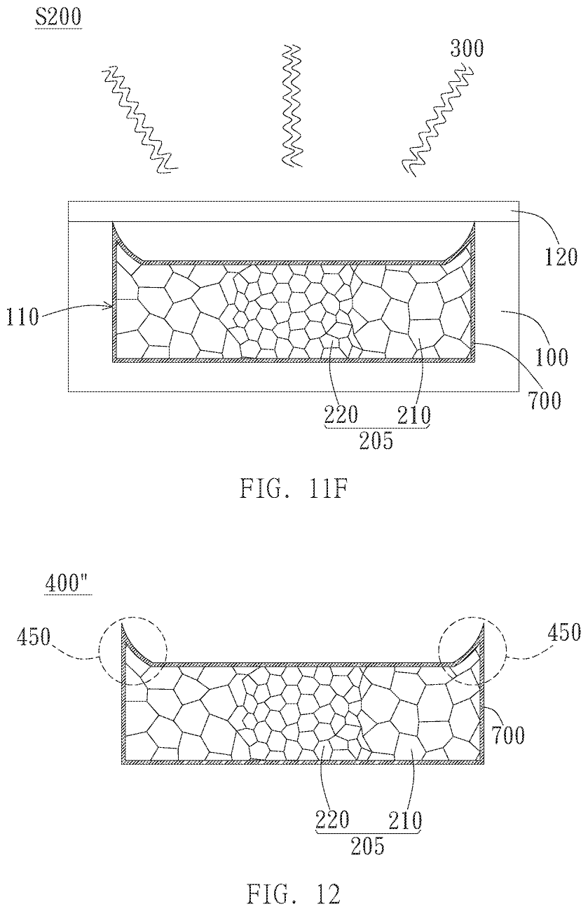

Specifically, with reference to FIG. 11A to FIG. 11F, the film-like component 700 comprises at least one foamable material, or the material that can be heated in the manner of microwave to partially melted and welded to other materials, and can be coated and defined the cladding space 720. Wherein, as shown in FIG. 11A to FIG. 11C sequentially, the foam matrix material 200 including the half-foamed granules 205 is set in the cladding space 720 that is covered and defined by the file-like component 700. Next, as shown in FIG. 11D and FIG. 11E subsequently, closed the film-like component 700 and setting the closed file-like component 700 with foam matrix material 200 inside to the mold 100, and then covered with top cover 120 on the mold 100 to prepare for foaming. As mentioned above, when the setting step S100 is completed, the cladding space 720 can comprise a main space 721 setting with half-foamed granules 205, an extension without setting half-foamed granules 205.

Next, referring to FIG. 11F together with FIG. 11A to FIG. 11E, when the above-described configuration is performing the foaming step S200, the half-foamed granules 205 are foamed and expanded along the cladding space 720 defined by the film-like component 700, and therefore the part of foamed expansion of the half-foamed granules 205 will extent and fill to the extension space 722. Thus, referring to FIG. 12, the completed foam molded body 400″ may have an extension 450 formed by filling the extension space 722 with the foamed half-foamed granules 205. Therefore, the desired detail structure or shape can be created by the configuration of the film-like component 700. For example, as shown in FIG. 12, the extension 450 may be a slightly convex flange on both side edges of the foam molded body 400″. The extension 450 described above, for example, can be used as a flange on both sides of the shoe component whereby to enhance the connection strength between the shoe component and other parts of the shoe, such as the upper, or to enhance the protective strength of the shoe body on both sides of the foot. However, the above is merely an example, and the present invention is not limited to the shape of the cladding space 720 shown here and the shape of the formed foam molded body 400″.

As described above, since the method for producing a foam molded body according to the present invention and the prepared foamed molded body can be used for the manufacture of a shoe component, according to other embodiments of the present invention, the foam molded body (i.e., the shoe component) completed and at the same time further connected with other parts of the shoe body or made other parts of the shoe body. Therefore, the preparation process can be further simplified and the preparation time or cost can be reduced.

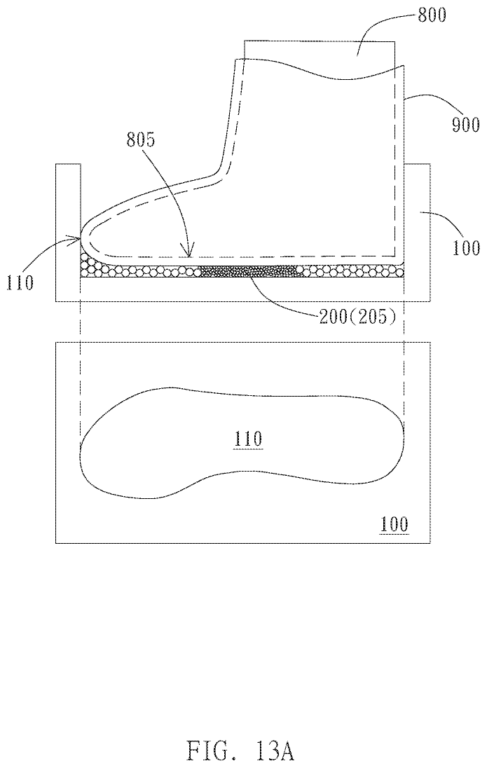

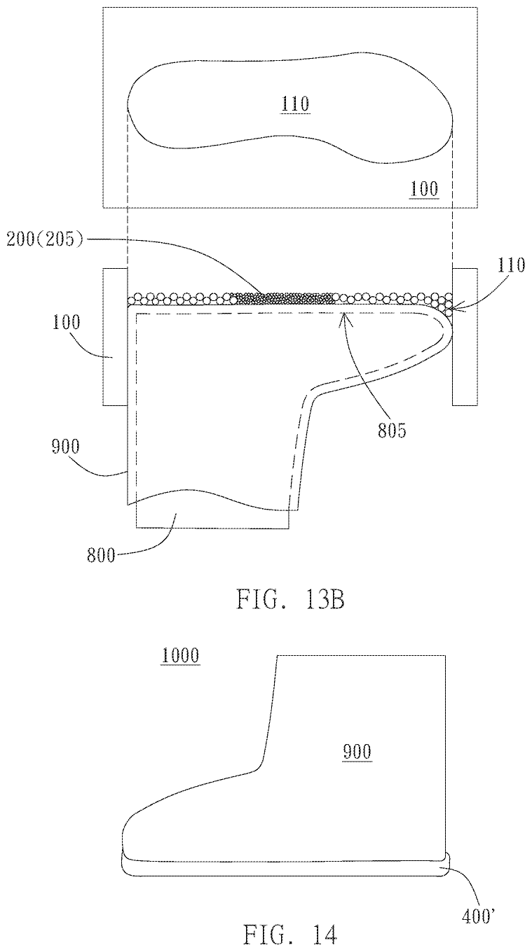

Specifically, referring to FIG. 13A and FIG. 13B, similar to FIG. 4, the cavity 110 of the mold 100 can have the shape of a shoe component. It is noted that, before the foaming step S200, the shoe last 800 covered with the upper 900 may be further disposed on the mold 100. Here, setting the shoe last 800 on the mold 100 is a relative concept, and is not limited to disposing the shoe last 800 on top of the mold 100 in the gravity direction. For example, as the embodiment shown in FIG. 13A, it can occur in the sequence that after the foam matrix material 200 includes the half-foamed granules 205 is placed in the mold 100 in the setting step S100, the shoe last 800 covered with the upper 900 is placed above the mold 100 (that is, above the gravity direction). Alternatively, as the embodiment shown in FIG. 13B, a shoe last 800 covered with an upper 900 is first placed in the mold 100 (i.e., in the direction opposite to the gravity direction), and a cavity 110 with a foam matrix material 200 is delimited by the mold 100 and the bottom 805 of the shoe last covered with the upper 900. Subsequently, the foam matrix material 200 containing the half-foamed granules 205 is set in the mold 100 and is loaded on the bottom 805 of the shoe last 800 covered with the upper 900.

As shown in FIG. 13A and FIG. 13B, before the foaming step S200, the shoe last 800 covering with the upper 900 can be further disposed on the mold 100, so that at least part of the upper 900 in contact with the half-foamed granules 205, and the half-foamed granules 205 disposed in the mold 100 are distributed along the bottom 805 of the shoe last 800. Therefore, when subsequent the foaming step S200, the half-foamed granules 205 are foamed with the manner of microwave heating in a fixed space, the half-foamed granules 205 can be joined and welded to each other via foaming and bonded with the upper 900 along the bottom 805 of the shoe last 800 at the same time. That is, the half-foamed granules 205may form an integrally the shoe component (i.e., the foam molded body 400′) which is bonded to the upper 900 at the points corresponding to the bottom 805 of the shoe last 80. Therefore, after the foaming step S200, the shoe last 800 can be removed to form the shoe 1000 which combines the upper 900 and the shoe component as shown in FIG. 14, and the process of bonding the shoe components and the upper 900 is not necessary after forming the shoe component.

According to some embodiments of the present invention, in order to make the shoe component (i.e., the foam molded body 400′) more smoothly bonded to the upper 900 while forming, the upper 900 may contain materials such as PU, TPU or TPE that do not foam or have the negligible foaming capability. For example, upper 900 may be woven from PU, TPU or TPE yarns. However, the present invention is not limited to this when it can be bonded to shoe body parts (i.e., foam forming body 400′).

Further, although not shown in the drawings, according to other embodiments of the present invention, the outsole material or the outsole can be laid on the half-famed granules 205 before the foaming step S200. For example, without the shoe last 800 and upper 900 set, the outsole material or the outsole can be simply laid on the half-famed granules 205; or with the shoe last 800 and the upper 900 set, the outsole material or the outsole can be laid on other side of the half-foamed granules 205 opposite to the shoe last 800 and the upper 900. In addition, when the outsole material or the outsole is scattered and not completely laid on the surface of the foam matrix materials 200, the outsole material or the sole can be laid on the surface of the foam matrix materials 200 according to the pattern expected of the outsole of the shoe. Thereby, one can optionally form the sole, the foamed molded body 400′ (for example, the foamed molded body 400′ as the midsole) and the upper 900, at the same time by welding their surface to each other in the foaming step S200.

According to some embodiments of the present invention, in order to make the shoe component (i.e., the foamed molded body 400′) more smoothly bonded to the sole or the sole material while forming, the sole or the sole material may include materials such as PU, TPU or TPE that do not foam or have a negligible foaming capability. However, the present invention is not limited to this when it can be bonded with the shoe component (i.e., foamed molded body 400′).

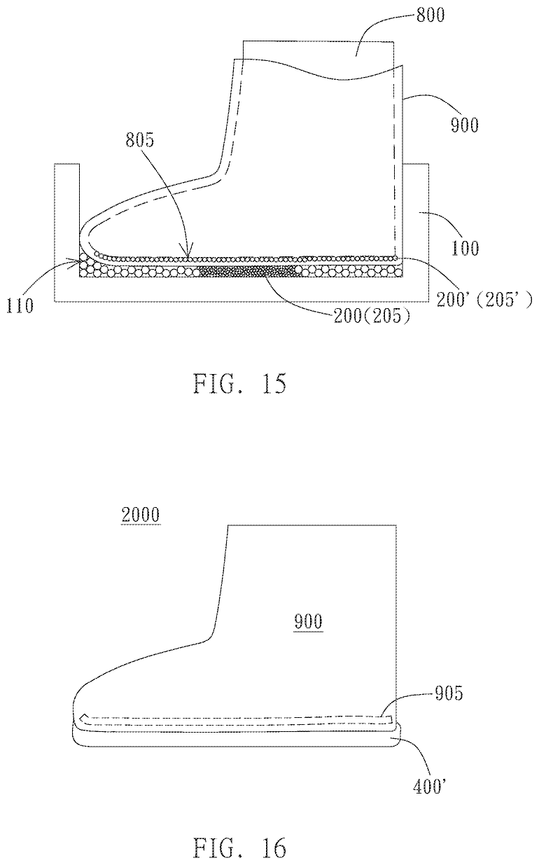

Next, referring now to FIG. 15 and FIG. 16, we will continue to describe a first variation embodiment of the above embodiment in which the shoe last 800 is set. Specifically, referring to FIG. 15, when the shoe last 800 covered with the upper 900 is provided, before the foaming step S200, half-foamed granules 205′, which may be of the same or different material from the half-foamed granules 205 in the molded 100 can be additionally distributed and laid along the bottom 805 of the shoe last 800 between the upper 900 and the shoe last 800. That is, the foam matrix material 200′, which includes half-foamed granules 205′, are additionally distributed and laid along the bottom 805 of the shoe last 800 between the upper 900 and the shoe last 800. Therefore, the half-foamed granules 205′ are also foamed by microwave heating in the foaming step S200 (for example, foaming due to temperature rise of itself caused by microwaves or due to temperature rise caused by surrounding materials such as additives). As shown in FIG. 16, the above-mentioned foamed half-foamed granules 205′ can be separately formed into another integrally-formed foamed molded body 905 independent of the foamed molded body 400′.

According to an embodiment, the foam forming body 905 can be a shoe insole of shoe 2000 formed after performing the foaming step S200 under the configuration of FIG. 15. That is, by means of a single foaming step S200, a shoe component (i.e., foamed molded body 400′), a shoe insole (i.e., foamed molded body 905) and an shoe component (i.e., foamed molded body 400′) and the shoe upper 900 can also be bonded.

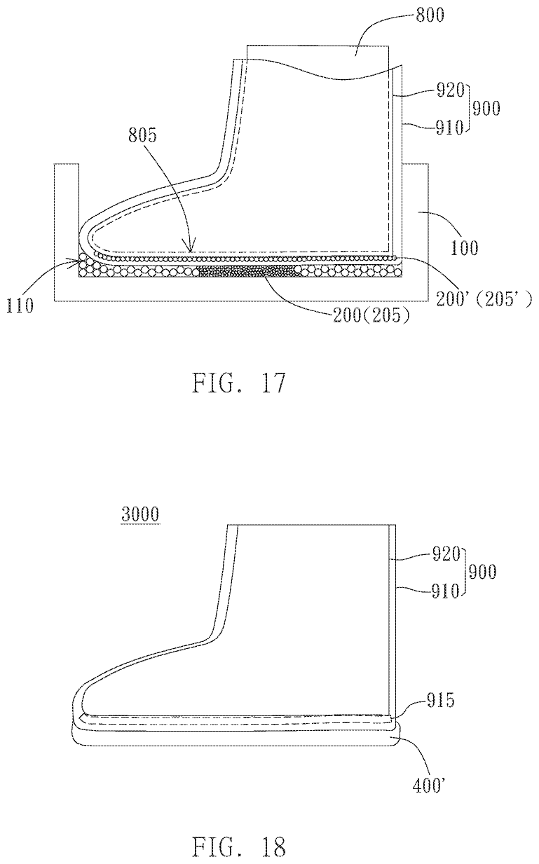

In addition, a second variation embodiment of the above embodiment based on the setting of shoe last 800 will be described below with reference to FIG. 17 and FIG. 18. Wherein, according to the second variation embodiment, the shoe last 800 may be covered with a double-layer upper 900, and the structure of the above-mentioned foamed molded body can be further formed between the double-layer uppers 900. In detail, referring to FIG. 17, the upper 900 that covers over the shoe last 800 has a double-layer structure including an outer layer 910 and an inner layer 920. Further, similar to the first variation embodiment described above with reference to FIG. 15 and FIG. 16, before foaming unit 200, the half-foamed granules 205′, which is the same or different from the half-foamed granules 205 in the molded 100 are additionally distributed and laid along the bottom 805 of shoe last 800 between the outer 910 and the inner 920 of upper 900. That is, the foamed matrix material 200′ comprising the half-foamed granules 205′ may be additionally disposed and laid along the bottom 805 of shoe last 800 between the outer 910 and the inner 920 of upper 900. Therefore, the half-foamed granules 205′ are also foamed by microwave heating in the foaming step S200 (for example, f foaming due to the temperature rise of itself caused by microwaves or the temperature rise caused by surrounding materials such as additives). As shown in FIG. 17, the above-mentioned foamed half-foamed granules 205′ can be separately formed into another integrally formed foamed molded body 915 independently of the foamed molded body 400′.

According to an embodiment, the foamed molded body 915 can be an insole or filler of shoe 3000 formed after performing the foaming step S200 with the configuration of FIG. 17. That is, by means of a single foaming step S200, the shoe component (i.e., foamed molded body 400′) embedded with the embedded component 600, the shoe insole or filler (i.e., foamed molded body 915) optionally embedded with the embedded component 600 can be simultaneously formed, and the shoe component (i.e., foamed molded body 400′) with the upper 900 can also be bonded.

Further, although not shown in the drawings, based on the third variation embodiment of the above-described embodiment where the shoe last 800 is set, the foamed molded body 905 or the foamed molded body 915 can be directly formed according to the above principle without forming the foam molded body 400′, and an embedded component 600′ can be set in at least one of the interiors thereof accordingly. Alternatively, based on the fourth variation embodiment of the above embodiment where the shoe last 800 is set’, the foamed molded body 905 and the foamed molded body 915 can be directly formed simultaneously, according to the above principle without forming the foam molded body 400′, and an embedded component 600′ can be set in at least one of the interiors thereof accordingly. Alternatively, based on the fifth variation embodiment of the above embodiment where the shoe last 800 is set, the foamed molded body 400′, the foamed molded body 905, and the foamed molded body 915 can also be simultaneously formed, and embedded component 600 and/or an embedded component 600′ can be embedded in at least one of the interiors thereof accordingly. As a result, it is to be understood that those skilled in the art can make various changes in accordance with the above principles.

Further, although not shown in the drawings, the waterproof moisture permeable film as described above can also be utilized in the embodiment in which the last 800 and the upper 900 are arranged. Specifically, the waterproof moisture permeable film can cover part of the foam matrix material 200 and part of the upper 900 at the same time, and be bonded with the formed shoe component (i.e., foamed molded body 400′) and the upper 900 after the foaming step S200, so that the part of the shoe component (i.e., the foamed molded body 400′) and the part of the upper 900 can have the functionality of being waterproof and moisture permeable. Similarly, the waterproof moisture permeable film can also be applied to other foamed molded bodies formed as described above, and will not be described herein.

In general, according to various embodiments of the present invention, the production of a foamed molded body or a shoe component with an embedded component can be completed in an integrated procedure by using a relatively inexpensive and simple microwave heating process. Specifically, the microwave heating process performed in accordance with various embodiments of the present invention compared to the conventional method of injection molding where the matrix material is required to be melted at a high temperature. Further, microwave heating causes the object of hearing to be heated up from the inside to the whole in a short time, which is faster and more uniform than the known method of heating from the outside to the inside. With microwave heating, the homogeneity of the final product can be improved, and the microstructures are not easily destroyed and can thus retain better microstructures and corresponding functions. Therefore, the properties and yield of the finished product can be improved, and the prepared foamed molded body or shoe component can have a desired embedded component, detail structure, shape or property. Thereby, the applicability of foamed molded body can be increased.

The foregoing is merely illustrative of some preferred embodiments of the present invention. It should be noted that various changes and modifications can be made in the present invention without departing from the spirit and scope of the invention. It will be apparent to those skilled in the Art that the present invention is defined by the scope of the appended claims, and that in accordance with the intention of this invention, all possible changes, combinations, modifications, referrals etc., shall not exceed the standard defined by the scope of the apply patent application of the present invention.

What is claimed is:

1. A method of manufacturing a foam molded body comprising:
a setting step, inputting a foam matrix material including a plurality of half-foamed granules of thermoplastic polyurethanes (TPU) into a mold that is not affected by microwave; and
a foaming step, heating the mold by microwave, wherein the half-foamed granules in the mold are affected by microwave such that the temperature thereof are raised to conduct foaming and are squeezed with each other, so as to form the foam molded body after cooling and demolding;
wherein the half-foamed granules include a plurality of first granules within a first grain size range, and a plurality of second granules within a second grain size range, and the median of the first grain size range is substantially larger than the median of the second grain size range; and
wherein, in the setting step, the first granules and the second granules are respectively disposed in different regions in the mold.

2. The method of claim 1, further comprising: placing one or more partitions in the mold in the setting step, and placing respectively he first granules and the second granules in the different regions in the mold that separate by the partitions.

3. The method of claim 2, wherein the partitions are made of a half-foamed material, and are heated to conduct foaming together with the half-foamed granules by the manner of microwave in the foaming step.

4. The method of claim 1, wherein a cavity of the mold is in the shape of a shoe component, and the foam molded body is a shoe component.

5. The method of claim 4, further comprising, prior to the foaming step, further comprises setting a shoe last covered with a upper on the mold, such that at least a portion of the upper contacts the half-foamed granules, so that the half-foamed granules setting in the mold distributed along the bottom of the shoe last of the shoe last.

6. The method of claim 5, before the foaming step, further comprising, additional distributed and laid the half-foamed granules that are the same as or different from the half-foamed granules along the bottom of the shoe last of the shoe last and between the upper and the shoe last.

7. The method of claim 5, wherein the upper that is covered over the shoe last has a two-layer structure, and prior to the foaming step, the method of manufacturing the foam molded body further comprises additional distributed and laid the half-foamed granules that are the same as or different from the half-foamed granules along the bottom of the shoe last of the shoe last and between the inner layer and the outer layer of the upper.

8. The method of claim 1, in the setting step, further comprises partially disposed one or more film-like components in the mold to be in contact with the half-foamed granules;
wherein the film-like components comprise a material that can be heated in a microwave method.

9. The method of claim 8, wherein at least one of the film-like components is a waterproof moisture permeable film, and before the foaming step, the method of fabricating the foam molded body further comprises covering at least a part of the half-foamed granules by waterproof moisture permeable film.

10. The method of claim 8, wherein at least one of the film-like components has a pattern, and the foam molded body formed by foaming has an indication pattern corresponding to the pattern.

11. The method of claim 8, wherein at least one of the film-like components comprises a foamable material or a material that can be heated in a microwave manner to partially melt and weld other materials, and the cladding defines a cladding space, and at least a part of the half-foamed granules disposed in the mold are disposed in the cladding space:
wherein, the cladding space includes an extension space in which the half-foamed granules are not disposed, and
wherein, the foam molded body has an extension part formed by foaming the half-foamed granules to fill the extension space.

12. The method of claim 1, before the foaming step, further comprising: at least one embedded component ranked together in the mold with the half-foamed granules, wherein the embedded component is a material or its finished product that is not affected by microwaves.

13. A foam molded body produced by the method of claims 1, wherein
the hardness of the part formed by the foaming of the first granules is smaller than the hardness of the part formed by the foaming of the second granules, and the density of the granules junction formed by the foaming of the first granules is lower than the density of the granules junction formed by the foaming of the second granules.

14. A shoe component produced by the method of claims 1, wherein the shoe component is the foam molded body with the shape of a shoe component, wherein
the hardness of the part formed by the foaming of the first granules is smaller than the hardness of the part formed by the foaming of the second granules, and the density of the granules junction formed by the foaming of the first granules is lower than the density of the granules junction formed by the foaming of the second granules.

15. A foam molded body, comprising a structure formed by foaming a plurality of the half-foamed granules of thermoplastic polyurethane (TPU), wherein
the half-foamed granules include a plurality of first granules within a first grain size range, and a plurality of second granules within a second grain size range;
the hardness of the part formed by the foaming of the first granules is smaller than the hardness of the part formed by the foaming of the second granules, and the density of the granules junction formed by the foaming of the first granules is lower than the density of the granules junction formed by the foaming of the second granules.

16. The foam molded body of claim 15, further comprising embedded at least one embedded component in the structure, and the embedded component is a material or a finished product thereof that is not affected by microwaves.

17. The foam molded body of claim 15, further comprising one or more film-like components welded or bond to each other to the surface of half-foamed granules, wherein at least one of the film-like components covers the structure.

18. The foam molded body of claim 17, wherein the at least one of the patterns of the film-like components corresponding attached to the foam molded body.

19. The foam molded body of claim 17, wherein at least one of the film-like components is a waterproof moisture permeable film.

20. The foam molded body of claim 15, wherein the foam molded body is a shoe component with a shape of a shoe component, wherein the shoe component is bonded to at least a part of an upper with a welded form.
